(19) United States
(12) Patent Application Publication
(10) Pub. No.: US 2003/0221358 A1
(43) Pub. Date: Dec. 4, 2003

(54) Swiveling fishing rod holder assembly

(76) Inventor: Mark Matlosz, Linden, NJ (US)

Correspondence Address: EZRA SUTTON, P.A., PLAZA 9, 900 ROUTE 9, WOODBRIDGE, NJ, 07095, US

(21) Appl. No.: 10/159,719

(22) Filed: Jun. 3, 2002

(51) Int. Cl. A01K 97/10

(52) U.S. Cl. 43/21.2

(57) ABSTRACT

The present invention provides an improved fishing rod holder assembly comprising a vertical post adapted to be mounted on a fishing boat. A support member is mounted on the vertical post and a cradle member is pivotally mounted relative to the support member. The fishing rod holder is fixedly connected to the cradle member and pivots with the cradle member relative to the support member and vertical post.

The support member has two radially extending stop members extending from the support member and the stop members are spaced up to 180° apart. A vertically extending engagement member is mounted on the bottom of the cradle member for engaging one of the stop members during the fishing operation.

The fishing rod holder and cradle member are adapted to be pivoted by the operator relative to the support member and vertical post away from the stop member and toward the inside of the boat in order to allow the operator to easily and safely remove the fishing rod from the fishing rod holder.

### FIELD OF THE INVENTION

The present invention relates to an improved fishing rod holder assembly that can be swivelled or pivoted so as to facilitate the removal of the fishing rod from the holder.

### BACKGROUND OF THE INVENTION

Fishing rod holders are often fixed in stationary positions. As such, it may be cumbersome or even dangerous to remove fishing rods from their holders when they are extended over the side of the boat and pointed toward the water. There is a need to swivel or pivot the fishing rod holder toward the inside of the boat so the fishing rod can be safely and easily removed from its holder by the operator without bending over the side of the boat.

It is an object of the present invention to provide a fishing rod holder that can pivot or swivel toward the inside of a fishing boat to facilitate the easy and safe removal of the fishing rod from its holder.

### SUMMARY OF THE INVENTION

The present invention provides an improved fishing rod holder assembly comprising a vertical post adapted to be mounted on a fishing boat. A support member is mounted on the vertical post and a cradle member is pivotally mounted relative to the support member. The fishing rod holder is fixedly connected to the cradle member and pivots with the cradle member relative to the support member and vertical post.

The support member has two radially extending stop members extending from the support member and the stop members are spaced up to 180° apart. A vertically extending engagement member is mounted on the bottom of the cradle member for engaging one of the stop members during the fishing operation.

The fishing rod holder and cradle member are adapted to be pivoted by the operator relative to the support member and vertical post away from the stop member and toward the inside of the boat in order to allow the operator to easily and safely remove the fishing rod from the fishing rod holder.

### BRIEF DESCRIPTION OF THE DRAWINGS

FIG. 1 shows a perspective view of the fishing rod holder assembly.

FIG. 2 shows a detailed view of the support member and the cradle member.

FIG. 3 shows a top view of the support member.

FIG. 4 shows a perspective view of the fishing rod holder assembly installed in the side of a boat.

### DETAILED DESCRIPTION OF THE PREFERRED EMBODIMENTS

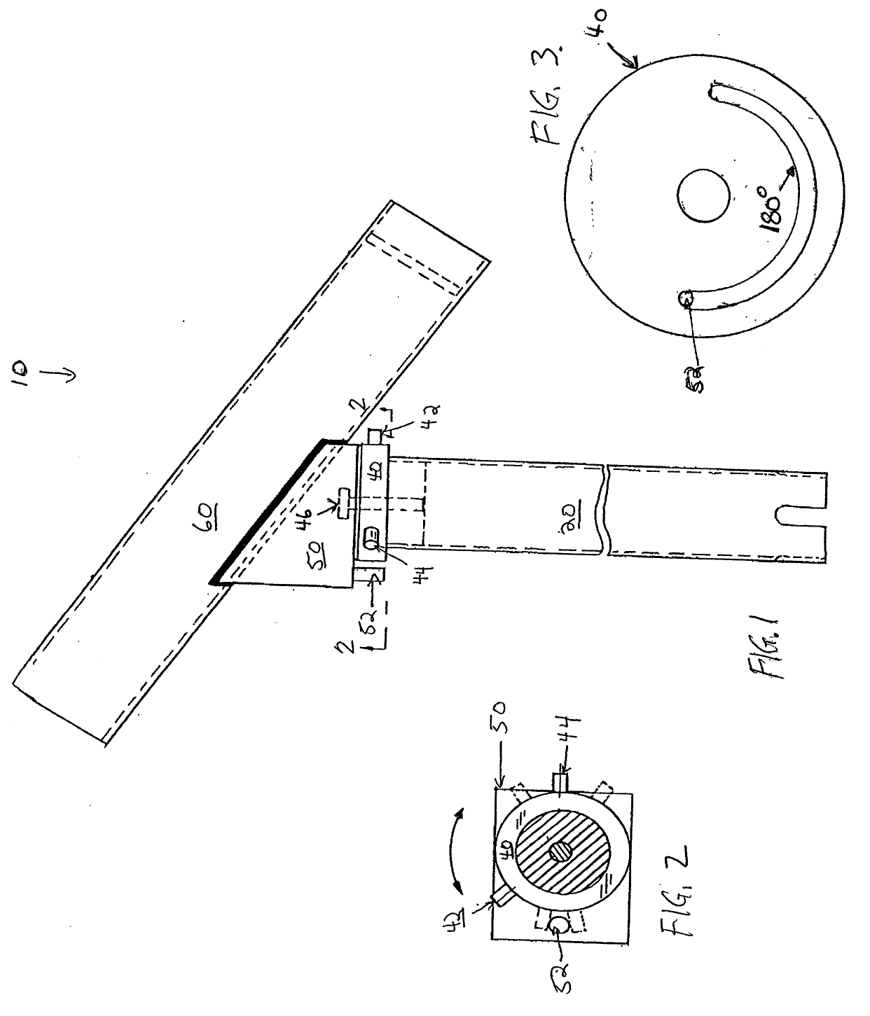

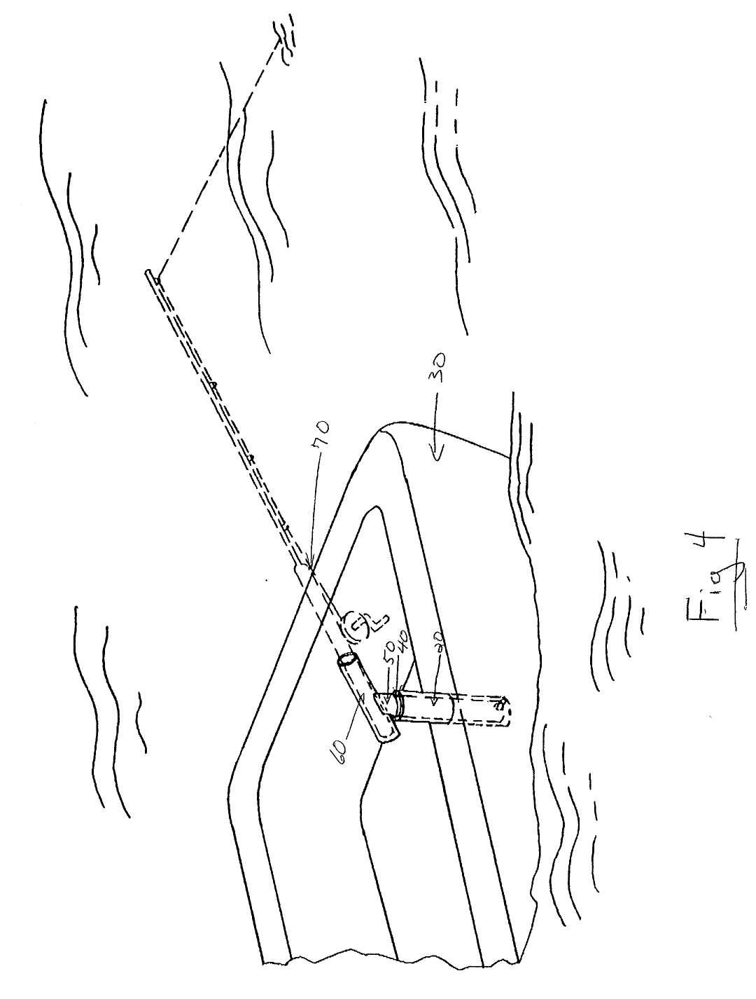

FIGS. 1 to 4 show an improved fishing rod holder assembly 10 comprising a vertical post 20 adapted to be mounted on the side of a fishing boat 30. A circular support member 40 is removably mounted on the vertical post 20 and a cradle member 50 is pivotally mounted relative to the support member 40. The fishing rod holder 60 is fixedly connected by welding to the cradle member 50 so as to pivot with the cradle member 50 relative to the support member 40 and the vertical post 20.

The support member 40 has two radially extending stop members 42 and 44 extending from the support member 40. The stop members 42 and 44 are spaced up to 180° apart and are in the form of stop pins 42 and 44.

A vertically extending engagement member 52 in the form of a vertical pin is mounted on the bottom of the cradle member 50 for engaging one of the stop members 42 and 44 during the fishing operation.

A pivot pin 46 is connected to cradle member 50 and vertical post 20 to allow cradle member 50 to pivot relative to vertical post 20.

The fishing rod holder 60 and the cradle member 50 are adapted to be pivoted by the operator relative to the support member 40 and vertical post 20 away from one of the stop pins 42 and 44 toward the other stop pin in order to allow the operator to remove the fishing rod 70 from the fishing rod holder 60.

The fishing rod holder 60 is connected to cradle ember 50 at an angle in the range of 15° to 75°.

During the fishing operation, vertical pin 52 engages stop pin 42 if assembly 10 is on one side of the boat, and vertical pin 52 engages stop pin 44 if assembly 10 is on the other side of the boat. In both cases, if the operator wishes to remove the fishing rod 70 from holder 60, the operator pivots holder 60 toward the inside of the boat, and this pivots vertical pin 52 away from one of the stop pins 42 or 44, and toward the other stop pin. In this manner, fishing rod 70 may be easily and safely removed from holder 60 when holder 60 is facing toward the inside of the boat.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A fishing rod holder assembly, comprising:
a) a vertical post adapted to be mounted on a fishing boat;
b) a support member removably mounted on said vertical post;
c) a cradle member pivotally mounted relative to said support member;
d) a fishing rod holder fixedly connected to said cradle member at an angle to pivot with said cradle member relative to said support member and said vertical post;
e) said support member having two radially extending stop members extending from said support member; said two stop members being spaced apart by less than 180°;
f) a vertically extending engagement member mounted on said cradle member for engaging one of said stop members during the fishing operation; and
g) said fishing rod holder and said cradle member adapted to be pivoted by the operator relative to said support member and said vertical post and away from one of said stop members toward the inside of the fishing boat in order to allow the operator to remove the fishing rod from said fishing rod holder.

2. A fishing rod holder assembly in accordance with claim 1, wherein said support member is circular in shape and said stop members are in the shape of stop pins; and said vertically extending engagement member is in the shape of a vertically extending pin for engaging said stop pins.

3. A fishing rod holder assembly in accordance with claim 1, wherein said vertical post member is adapted to be mounted on either side of a fishing boat, and wherein one stop member is engaged on one side of the boat, and wherein the other stop member is engaged on the other side of the boat.

4. A fishing rod holder in accordance with claim 1, wherein said fishing rod holder is connected to said cradle member at an angle in the range of 15° to 75°.

5. A fishing rod holder in accordance with claim 1, wherein a pivot pin is connected to said cradle member and to said vertical post to allow said cradle member to pivot relative to said vertical post.
